(19) United States
(12) Patent Application Publication
(10) Pub. No.: US 2025/0074403 A1
(43) Pub. Date: Mar. 6, 2025

(54) VEHICULAR DRIVING ASSIST SYSTEM

(71) Applicant: Magna Electronics Inc., Auburn Hills, MI (US)

(72) Inventor: Ashesh Goswami, Somerville, MA (US)

(21) Appl. No.: 18/817,432

(22) Filed: Aug. 28, 2024

Related U.S. Application Data
(60) Provisional application No. 63/579,991, filed on Sep. 1, 2023.

(51) Int. Cl. B60W 30/09; B60W 10/04; B60W 10/20; B60W 30/095

(52) U.S. Cl. CPC B60W 30/09; B60W 10/04; B60W 10/20; B60W 30/0956; B60W 2420/408

(57) ABSTRACT

A vehicular driving assist system includes a sensor disposed at a vehicle. The vehicular driving assist system determines first and second sets of angular velocities via processing sensor data captured by the sensor. The first set of angular velocities is determined at a first time and the second set of angular velocities is determined at a second time that is after the first time. The vehicular driving assist system converts the first and second sets of angular velocities into respective first and second sets of Cartesian velocities, and pairs each angular velocity from the first set of angular velocities with a corresponding angular velocity from the second set of angular velocities to generate a set of paired Cartesian velocities. The vehicular driving assist system determines velocity of a detected object based on the set of paired Cartesian velocities and controls the equipped vehicle based on the determined velocity.

### CROSS REFERENCE TO RELATED APPLICATION

The present application claims the filing benefits of U.S. provisional application Ser. No. 63/579,991, filed Sep. 1, 2023, which is hereby incorporated herein by reference in its entirety.

### FIELD OF THE INVENTION

The present invention relates generally to a vehicle sensing system for a vehicle and, more particularly, to a vehicle sensing system that utilizes one or more sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular driving assist system includes a sensor disposed at a vehicle equipped with the vehicular driving assist system and that senses exterior of the vehicle and that is operable to capture sensor data. The vehicular driving assist system also includes an electronic control unit (ECU) that has electronic circuitry and associated software. The electronic circuitry of the ECU includes at least one data processor and the ECU is operable to process captured sensor data provided to the ECU. The vehicular driving assist system, via processing at the ECU of sensor data captured by the sensor, detects an object present exterior of the equipped vehicle. The vehicular driving assist system, via processing at the ECU of captured sensor data, determines a first set of angular velocities for the detected object. The vehicular driving assist system, via processing at the ECU of captured sensor data, determines a second set of angular velocities for the detected object. The first set of angular velocities for the detected object is determined at a first time and the second set of angular velocities for the detected object is determined at a second time that is after the first time. The vehicular driving assist system converts (i) the first set of angular velocities into a first set of Cartesian velocities and (ii) the second set of angular velocities into a second set of Cartesian velocities. The vehicular driving assist system pairs each angular velocity from the first set of angular velocities with a corresponding angular velocity from the second set of angular velocities to generate a set of paired Cartesian velocities for the detected object. The vehicular driving assist system determines velocity of the detected object relative to the equipped vehicle based on the set of paired Cartesian velocities for the detected object and controls the equipped vehicle based at least in part on the determined velocity of the detected object relative to the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is a plan view of a vehicle implementing a radar sensor capturing multiple radar detections from a single object; and

FIG. 3 is a plan view of a vehicle determining a velocity of a first point from a detected object given the velocity of a second point from the detected object.

### DESCRIPTION OF THE PREFERRED EMBODIMENTS

A vehicle sensing system and/or driver or driving assist system and/or object detection system and/or alert system operates to capture sensing data exterior of the vehicle and may process the captured data to detect objects at or near the vehicle and in the predicted path of the vehicle, such as to assist a driver of the vehicle in maneuvering the vehicle in a forward or rearward direction. The system includes a processor that is operable to process sensor data that is transferred to the processor from one or more sensors (e.g., radar sensors, lidar sensors, ultrasonic sensors, etc.) and provide an output, such as an alert or control of a vehicle system.

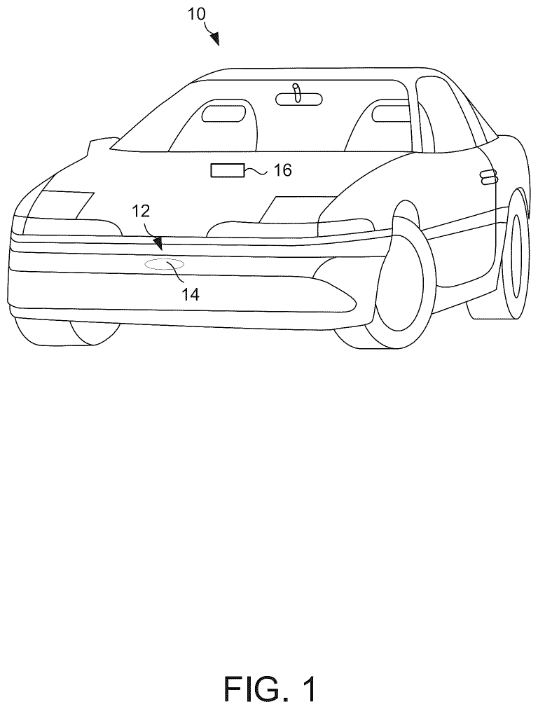

Referring now to the drawings and the illustrative embodiments depicted therein, a vehicle 10 (FIG. 1) includes an driving assistance system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, and a sideward/rearward facing sensor at respective sides of the vehicle), which sense regions exterior of the vehicle. The sensing system 12 includes a control or electronic control unit (ECU) that includes a data processor that is operable to process data captured by the radar sensor(s). The sensing system may also include a radar sensor that includes plurality of transmitters that transmit radio signals via plurality of antennas. The radar sensor also includes a plurality of receivers that receive radio signals via the plurality of antennas. The radar sensor may include a printed circuit board (PCB) that has electronic circuitry and associated software. The circuitry may have a processor operable to process sensor data captured by the radar sensor to detect an object in an area surrounding the vehicle. The object may be a pedestrian walking in a path toward the vehicle or in a path that may intersect a path of travel of the vehicle, or the object may be another vehicle traveling along the same road as the equipped vehicle (such as in the same direction or opposite direction along the road) or traveling along a road that intersects the road along which the equipped vehicle is traveling. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

Autonomous vehicles and vehicles with advanced driver assist systems (ADAS) rely on information from various sensors including imaging sensors or cameras, radar sensors, and/or lidar sensors. In particular, these autonomous vehicles and driving assistance systems include sensing systems that implement instantaneous or substantially instantaneous detection models (i.e., object detection and object tracking models) that process sensor data from these various sensors to detect and track objects located in the environment surrounding the vehicle. Yet, the detection models are oftentimes constrained by the sensor data captured by the sensors. For example, cameras capture image data that does not directly include velocity information of the objects captured by the image data. Extracting velocity information from the image data can be a non-trivial and difficult process for detection models. To that end, many sensing systems implement other sensors, such as Frequency Modulated Continuous Wave (FMCW) sensors, that directly captures velocity (i.e., Doppler) information of the detected objects. The FMCW sensors may be radar sensors or lidar sensors.

However, a drawback to using these other sensors is that the velocity information includes radial velocity for multiple different points of a detected object while detection models generally work with Cartesian coordinates, and thus, cannot readily process the captured radial velocities. Simply put, the detection models expect any captured velocity information to be in the Cartesian coordinate format of (e.g., (x, y) velocities) rather than the radial (i.e., angular) velocities that are captured by radar and lidar sensors. This problem is further complicated by the fact that radar and lidar sensors capture the radial velocity at multiple points of each detected object. One current approach to this problem includes implementing multiple sensors that provide information across multiple different dimensions thereby allowing detection models to determine current or instantaneous Cartesian velocities from individual angular velocities for every measurement point. However, this approach requires a cumbersome process of integrating sensor data from multiple sensors to determine the Cartesian velocities. Another current approach includes utilizing a tracking framework model (e.g., Kalman Filter-based approach) that leverages temporal information over a range of time to estimate the velocities of the tracked objects. The tracking framework model requires processing data over multiple points in time which is computationally expensive.

Implementations herein are directed towards a vehicular sensing system 12, such as a radar sensing system that includes a sensor (e.g., an imaging sensor or a non-imaging sensor, such as a radar sensor, a lidar sensor, an ultrasonic sensor, etc.) sensing exterior of the equipped vehicle by capturing sensor data, for example, radar data. The sensors may be located at one or both side mirrors of the vehicle and/or at a roof-top of the vehicle. Additionally or alternatively, the sensors may be located at front and/or rear corners of the vehicle, such as each corner of the vehicle (e.g., at the bumpers). The vehicular sensing system may include an electronic control unit (ECU) having a data processor for processing the sensor data captured by the sensor. In some examples, the vehicular sensing system includes a single sensor, for example, a single radar sensor. Alternatively, the data processor may only process sensor data from a respective one of the sensors at a given time despite the availability of sensor data from multiple sensors at the given time. The system leverages point-cloud information directly for performing velocity estimation (instead of a time-derivative of position), while relying on a general sense of the object over two instances of time (without the requirement of a full-blown tracker). This helps in achieving a semi-instantaneous estimation of Cartesian velocities which can be of great advantage in a multi-sensor perception system.

In some examples, a detection model may use a method of least squares to fit a probability distribution to a set of data. The least squares method involves estimating parameters by the squared discrepancies between observed data and the corresponding expected data. Yet, an overdetermined system of equations (e.g., Ax=b) has no discrete solutions. Thus, determining the vector x that is the closest to being a solution for the system of equations is referred to as the least square solution. Accordingly, a system of linear equations can be solved by the least square solution and may be represented by equation (1). Singular Value Decomposition (SVD), QR decomposition are some of the common methods of solving such linear square systems.

$$( \begin{matrix}{a}_{11} & {a}_{12} & ... & {a}_{1 n} \\ {a}_{21} & {a}_{22} & ... & {a}_{2 n} \\ . & . & . & . \\ . & . & . & . \\ {a}_{m 1} & {a}_{m 2} & ... & {a}_{mn}\end{matrix} ) ( \begin{matrix}{x}_{1} \\ {x}_{2} \\ . \\ . \\ {x}_{n}\end{matrix} ) = ( \begin{matrix}{b}_{1} \\ {b}_{2} \\ . \\ . \\ {b}_{n}\end{matrix} ) \qquad ( 1 )$$

$$Ax = b$$

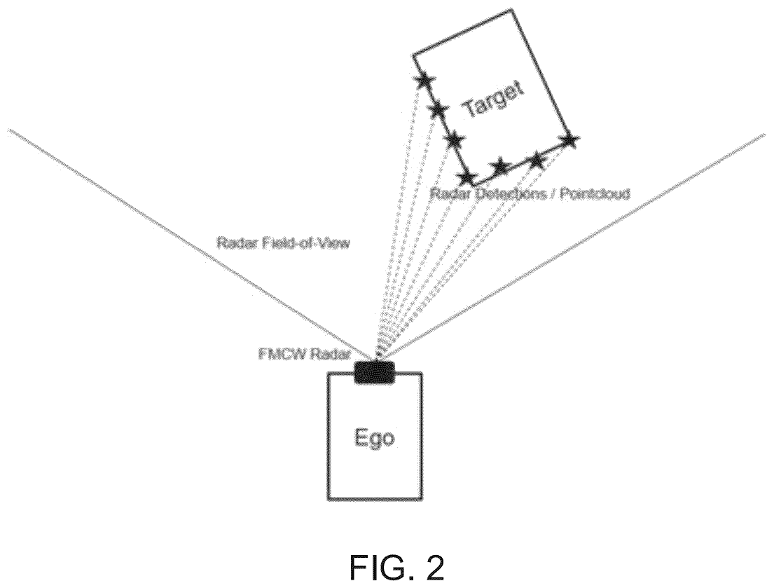

FIG. 2 shows a sensor implemented on the vehicle capturing sensor data (i.e., radar data) from a single object within a field of view of the sensor. In the example shown, the sensor captures sensor data that includes multiple radar detections (i.e., measurement points) from the single detected object. Each radar detection may include range data, Doppler data, azimuth data, elevation data, and power data, among other data. The collection of the multiple radar detections at each instance in time may be referred to as a radar point-cloud of data. Notably, the radar detections include radial (i.e., Doppler or angular) velocities of the object, but the detection model implemented by vehicular radar sensing systems expects Cartesian velocities. In some examples, the vehicular radar sensing system may assume the elevation data from each radar detection is not available and set the elevation data equal to zero degrees.

Assuming the detected object is moving in a perfectly linear motion, the Cartesian velocity at each measurement point of the object will be the same. Under this assumption, the radar sensing system can determine a range rate for each radar detection (i.e., measurement point) from the radar point-cloud of data according to:

$$r = {v}_{( x , obj )} * cos θ + {v}_{( y , obj )} * sin θ \qquad ( 2 )$$

However, Equation (1) requires the assumption that detected objects travel in perfectly linear motions (e.g., with no angular motion), which is rarely (if ever) true in many scenarios. Moreover, Equation (1) corresponds to determining the range rate when the sensor is static or stationary. To compensate for scenarios when the sensor is in motion (e.g., the sensor and/or vehicle is moving) the vehicular sensing system determines the resulting Doppler distortion of the sensor and determines a modified range rate according to:

$${r}^{c} = r + {v}_{( x , ego )} * cos θ + {v}_{( y , ego )} * sin θ \qquad ( 3 )$$

Equations (2) and (3) determine the range rate for a single radar detection from the radar point-cloud of data for the detected object. Applying the least square solution to Equations (2) and (3), the detection model can determine the range rate for any number N of radar detections from the radar point-cloud of data captured by the sensor represented by:

$$( \begin{matrix}{r}_{1}^{c} \\ {r}_{2}^{c} \\ .. \\ .. \\ {r}_{N}^{c}\end{matrix} ) = ( \begin{matrix}cos {θ}_{1} & sin {θ}_{1} \\ cos {θ}_{2} & sin {θ}_{2} \\ .. & .. \\ .. & .. \\ cos {θ}_{N} & sin {θ}_{N}\end{matrix} ) ( \begin{matrix}{v}_{( x , obj )} \\ {v}_{( y , obj )}\end{matrix} ) \qquad ( 4 )$$

Moreover, in some implementations, some of the radar detections captured by the sensor include noisy data. As such, the radar sensing system may apply outlier rejection to improve the quality of the radar detections used to determine the velocity of the detected object. For example, the radar sensing system may apply Random Sample Consensus (RANSAC) to randomly choose a minimal set of radar detections and determine a likelihood that each randomly chosen radar detection includes noisy data. If the likelihood satisfies a threshold (e.g., exceeds a noise threshold), the radar sensing system may randomly select another set of radar detections or replace the noisy radar detection with another radar detection.

In some implementations, the radar sensing system uses a state space model to detect single objects or multiple objects present in the scene surrounding the vehicle. For example, the state space model may use a Kalman Filter state estimation technique. The state space equation may be represented by:

$${X}_{k + 1} = F ( {ω}_{k} ) {X}_{k} + w \qquad ( 5 )$$

In Equation (5), Xₖ₊₁ represents a propagated state of the detected object, Xₖ represents a current state of the detected object, ωₖ represents the assumed turn-rate (i.e., changing rate of heading angle of detected object), w represents a noise vector, and F represents the state space model. Thus, the state space vector, including positions and velocities of the detected object, may be represented by:

$$X = {[ {xv}_{x} {yv}_{y} ]}^{′} \qquad ( 6 )$$

In Equation (6), x represents longitudinal position (in meters), vₓ represents longitudinal velocity (in meters/second), y lateral position (in meters), and v_{y} lateral velocity (in meters/second). Moreover, the state space model F from Equation (5) may be represented by:

$$F = ( \begin{matrix}1 & \frac{sin {ω}_{k} t}{{ω}_{k} t} & 0 & - \frac{1 - cos {ω}_{k} t}{{ω}_{k} t} \\ 0 & cos {ω}_{k} t & 0 & - sin {ω}_{k} t \\ 1 & \frac{1 - cos {ω}_{k} t}{{ω}_{k} t} & 0 & \frac{sin {ω}_{k} t}{{ω}_{k} t} \\ 0 & sin {ω}_{k} t & 0 & cos {ω}_{k} t\end{matrix} ) \qquad ( 7 )$$

The velocity estimation approach described herein may rely on several assumptions. First, velocity estimation of objects utilizes a group of detections assumed to be from the same object over two subsequent time instances. That is, accurate clustering or grouping of detections (from the same object) for every time instance is not within the scope of the velocity estimation approach described herein. Moreover, accurate association of a cluster management from a current time instance to the propagated track from a previous time instance is not within the scope of this disclosure. The accurate association of the cluster management only helps track the detected object over a period of time. Second, the sensing system assumes the vehicle operates within a known or predetermined operating range of yaw-rate, such as road curvature, vehicle maneuvers, etc. That is, the sensing system may assume the yaw-rate remains less than a threshold amount. If the vehicle operates outside of the predetermined range, accuracy of the velocity estimation may be degraded. Third, resolution of the estimated velocity accuracy (e.g., primarily yaw-rate) is dependent upon the discretization of yaw-rate. In turn, the discretization of yaw-rate is dependent upon the processing power of the sensing system (e.g., processing power of the processor, ECU, or other hardware). Fourth, velocities of the detected object, including both linear and angular yaw-rate, are expected to remain the same between two subsequent time instances. Because most sensing systems operate at a high frequency, for example, 50 Hertz, the assumption that the velocities of the detected object remain the same between two subsequent time instances is reasonable. For example, the system may assume a first velocity of the detected object at a first and second time instance and assume a second velocity, different than the first velocity, of the detected object at a third and fourth time instance. Thus, given this assumption, the sensing system may be applicable within a predetermined operating range of vehicle speed and/or acceleration/deceleration limits.

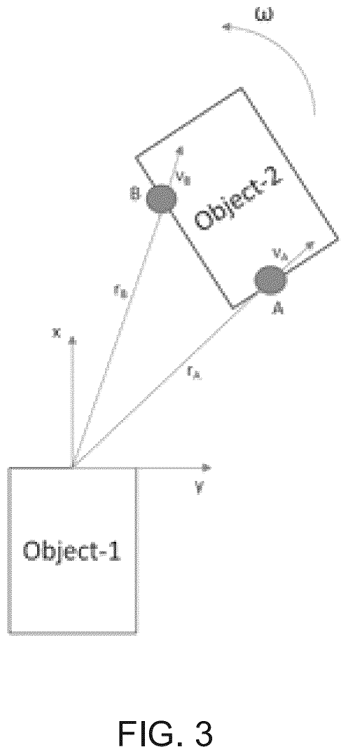

FIG. 3 shows an example for determining the velocity at a first point of a detected object (e.g., point A) using a given or known velocity at a second point of the detected object (e.g., point B). The points refer to different locations along one or more surfaces of the object. The known parameters shown in FIG. 3 are represented by:

$$\vec{{v}_{B}} = {v}_{y} \hat{ι} + {v}_{x} \hat{J} \qquad ( 8 )$$

$$\vec{{r}_{A}} = {y}_{A} \hat{ι} + {x}_{A} \hat{J} \qquad ( 9 )$$

$$\vec{{r}_{B}} = {y}_{B} \hat{ι} + {x}_{B} \hat{J} \qquad ( 10 )$$

Here, \vec{ν_{B}} (Equation (8)) represents the given velocity at point B, \vec{r_{A}} (Equation (9)) represents the range rate at point A, and \vec{r_{B}} represents the range rate at point B. Thus, it follows that for an object undergoing linear and angular velocity (i.e., linear and angular motion), the velocity at point A may be determined by:

$$\vec{{v}_{A}} = \vec{{v}_{B}} + ω \times \vec{{r}_{A / B}} \qquad ( 11 )$$

$$\vec{{v}_{A}} = \vec{{v}_{B}} + ω \times ( \vec{{r}_{A}} - \vec{{r}_{B}} ) \qquad ( 12 )$$

Using the velocity at point A represented in Equation (12) and using the notations from Equations (8)-(10), the sensing system may obtain the following:

$$\vec{{v}_{A}} = {v}_{( y , B )} \hat{ι} + {v}_{( x , B )} \hat{J} + ω \hat{k} \times ( {y}_{A} \hat{ι} + {x}_{A} \hat{J} - {y}_{B} \hat{ι} - {x}_{B} \hat{J} )$$

$$\vec{{v}_{A}} = {v}_{( y , B )} \hat{ι} + {v}_{( x , B )} \hat{J} + ω \hat{k} \times ( ( {y}_{A} - {y}_{B} ) \hat{ι} + ( {x}_{A} - {x}_{B} ) \hat{J} )$$

$$\vec{{v}_{A}} = {v}_{( y , B )} \hat{ι} + {v}_{( x , B )} \hat{J} + ω \hat{k} \times ( ( {y}_{A} - {y}_{B} ) \hat{ι} + ω \hat{k} \times ( {x}_{A} - {x}_{B} ) \hat{J}$$

$$\vec{{v}_{A}} = {v}_{( y , B )} \hat{ι} + {v}_{( x , B )} \hat{J} + ω ( {y}_{A} - {y}_{B} ) ) \hat{J} + ω ( {x}_{A} - {x}_{B} ) ) \hat{ι}$$

$$\vec{{v}_{A}} = ( {v}_{( y , B )} - ω ( {x}_{A} - {x}_{B} ) ) \hat{ι} + ( {v}_{( x , B )} + ω ( {y}_{A} - {y}_{B} ) ) \hat{J}$$

$${v}_{( y , A )} = {v}_{( y , B )} - ω ( {x}_{A} - {x}_{B} )$$

$${v}_{( x , A )} = {v}_{( x , B )} - ω ( {y}_{A} - {y}_{B} )$$

Thereafter, the sensing system may select a reference point P (x_{ref}, y_{ref}) from the detected object and determine the velocity at the reference point Vₚ (x_{ref}, y_{ref}) at every radar detection i, represented by:

$${r}_{i}^{c} = {v}_{( x , i )} cos {θ}_{i} + {v}_{( y , i )} sin {θ}_{i} \qquad ( 13 )$$

$${r}_{i}^{c} = ( {v}_{( x , ref )} + ω ( {y}_{i} - {y}_{ref} ) ) cos {θ}_{i} + ( {v}_{( y , i )} - ω ( {x}_{i} - {x}_{ref} ) ) sin {θ}_{i} \qquad ( 14 )$$

$${r}_{i}^{c} = cos {θ}_{i} {v}_{( x , ref )} + sin {θ}_{i} {v}_{( y , ref )} + ω ( ( {y}_{i} - {y}_{ref} ) cos {θ}_{i} - ( {x}_{i} - {x}_{ref} ) sin {θ}_{i} ) \qquad ( 15 )$$

When determining the velocity of the detected object, the sensing system may not assume that every point of the detected moving object has the same linear Cartesian velocities as other approaches assume. Instead, the sensing system may use yaw-rate (i.e., angular velocity) together with range-rate information to determine the velocity of detected objects. That is, using the equations above, the radar detection system establishes a relationship between range-rate of detections, Cartesian linear velocities, and angular velocities from the radar detections captured by the sensor. Using these relationships, the radar sensing system may determine or estimate the Cartesian velocity of the detected object for a single value of yaw-rate (i.e., angular velocity) according to:

$${r}_{i}^{c} - ω ( ( {y}_{i} - {y}_{ref} ) cos {θ}_{i} - ( {x}_{i} - {x}_{ref} ) sin {θ}_{i} ) = cos {θ}_{i} {v}_{( x , ref )} + sin {θ}_{i} {v}_{( y , ref )} \qquad ( 16 )$$

For a single known value of yaw-rate ω (e.g., obtained from the sensor data), the values on the left-hand side of Equation (16) are all known except for rᵢ^{c}. As such, Equation (16) can be simplified and represented by:

$${( {r}_{i}^{c} )}_{eff} = cos {θ}_{i} {v}_{( x , ref )} + sin {θ}_{i} {v}_{( y , ref )} \qquad ( 17 )$$

In Equation (17), (rᵢ^{c})_{eff} may be defined according to:

$${( {r}_{i}^{c} )}_{eff} = ω ( ( {y}_{i} - {y}_{ref} ) cos {θ}_{i} - ( {x}_{i} - {x}_{ref} ) sin {θ}_{i} ) \qquad ( 18 )$$

Finally, the radar detection system may use Equation (17) to determine the Cartesian velocities of the radar detection of the object according to:

$$( \begin{matrix}{( {r}_{1}^{c} )}_{eff} \\ {( {r}_{2}^{c} )}_{eff} \\ … \\ … \\ {( {r}_{N}^{c} )}_{eff}\end{matrix} ) = ( \begin{matrix}cos {θ}_{1} & sin {θ}_{2} \\ cos {θ}_{2} & sin {θ}_{2} \\ … & … \\ … & … \\ cos {θ}_{N} & sin {θ}_{N}\end{matrix} ) ( \begin{matrix}{v}_{( x , ref )} \\ {v}_{( y , ref )}\end{matrix} ) \qquad ( 19 )$$

In some implementations, the radar points include noisy detections due to artifacts including multi-bounce, azimuth ambiguity, etc. Accordingly, as discussed above, the sensing system may apply an outlier rejection (e.g., RANSAC) to reduce the effects of noise on the quality of the Cartesian velocity estimates.

After determining the Cartesian velocity for the single angular velocity, the sensing system may determine multiple Cartesian velocity estimates each corresponding to a respective angular velocity over a range of angular velocities ωj∈[ωₘᵢₙ, ωₘₐₓ] for the detected object. Simply put, the sensing system repeats the process of determining the Cartesian velocity for every angular velocity from the range of angular velocities according to:

$$( \begin{matrix}{( {r}_{1}^{c} )}_{eff}^{{ω}_{j}} \\ {( {r}_{2}^{c} )}_{eff}^{{ω}_{j}} \\ … \\ … \\ {( {r}_{N}^{c} )}_{eff}^{{ω}_{j}}\end{matrix} ) = ( \begin{matrix}cos {θ}_{1} & sin {θ}_{2} \\ cos {θ}_{2} & sin {θ}_{2} \\ … & … \\ … & … \\ cos {θ}_{N} & sin {θ}_{N}\end{matrix} ) {( \begin{matrix}{v}_{( x , ref )} \\ {v}_{( y , ref )}\end{matrix} )}^{{ω}_{j}} \qquad ( 20 )$$

Using the Cartesian velocities determined from Equation (20), the detection model generates a set of Cartesian velocity estimates corresponding to the Nth cycle operation (i.e., time step) according to:

$${V}_{N} = [ {( {v}_{x , ref} , {v}_{y , ref} )}^{{ω}_{1}} , {( {v}_{x , ref} , {v}_{y , ref} )}^{{ω}_{2}} , … , {( {v}_{x , ref} , {v}_{y , ref} )}^{{ω}_{J}} ] \qquad ( 21 )$$

In Equation (21), there are J pairs of Cartesian velocity estimates corresponding to the current cycle operation N where each cycle indicates a point in time or time step or time instance. Stated differently, each N indicates a time cycle of sensor data captured by the sensor.

Using the set of Cartesian velocity estimates from two subsequent or adjacent time cycles, for example, a first time step and a second time step, the radar sensing system links or associates each respective Cartesian velocity estimate from a first time step to a corresponding respective Cartesian velocity estimate from a second time step. Here, the first and second time steps may be adjacent time steps (i.e., the second time step immediately follows the first time step). Moreover, the radar sensing system may record relevant information from the N^{th} and (N−1)^{th} time step. For example, using a clustering model (i.e., a density-based clustering algorithm), the multiple radar detections obtained from the sensor and the corresponding time step may be recorded. More specifically, the (x, y) position of the cluster from the radar point-cloud of data in the (N−1)^{th} time step and the radar point-cloud of data linked to the detected object under consideration from the (N−1)^{th} time step may be recorded. Thereafter, the cluster centroid from the (N−1)^{th} time cycle may be propagated to the current time step using a kinematic model. The kinematic model may be used from Equations (5)-(7), however, any other kinematic model may be used. After the cluster position from the (N−1)^{th} time step is propagated, any data association approach may associate (i.e., pair) the clusters from the two adjacent time steps. One data association approach may include the Hungarian algorithm with distance-based cost. The data association generates a resulting set of cluster pairs from the adjacent time steps.

Finally, after linking the detection from two subsequent time steps, the radar sensing system determines a full velocity estimation of the detected object. In particular, the radar sensing system uses the state space propagation model F (Equation (7)) for every value of ω (e.g., a total of J pairs from Equation (20)) and the state space information X (Equation (6)) from two adjacent time steps (e.g., Tᵢ and Tᵢ₋₁). Stated differently, for every angular velocity ω, the radar sensing system estimates the predicted state space vector at Tᵢ using the state space information from Tᵢ₋₁ and the corresponding propagation model represented by:

$${X}_{{T}_{i {\vert}_{\vert ω = {ω}_{j}}}}^{pred} = F {\vert}_{ω = {ω}_{1}} \cdot {X}_{{T}_{{i - 1 \vert}_{ω = {ω}_{j}}}} \qquad ( 22 )$$

Thereafter, the radar sensing system extracts the (x, y) position values from the state space vectors and stores the position values as X′ and generate a vector to store all the J predicted state space subsets as well as the measured cluster position X′_{Ti} from the Tᵢ current time step represented by:

$${X}_{{T}_{i}}^{′ pred} = [ {X}_{{T}_{{i \vert}_{ω = {ω}_{1}}}}^{pred} , {X}_{{T}_{{i \vert}_{ω = {ω}_{2}}}}^{pred} , … , {X}_{{T}_{{i \vert}_{ω = {ω}_{J}}}}^{pred} ] \qquad ( 23 )$$

Finally, the radar sensing system determines a yaw-rate value w (i.e., angular velocity) that minimizes a L2 norm error between the predicted and measured state by finding the value of the index (j) that minimizes the L2 norm error. Once the yaw-rate that minimizes the L2 norm error is identified, the corresponding velocity estimates will complete the velocity estimation process for the current time step operation according to:

$$ω = arg {min}_{j ∈ [ 1 , 2 , … , J ]} {‖ {X}_{{T}_{i {\vert}_{\vert {ω}_{j}}}}^{′ pred} - {X}_{{T}_{i}}^{′} ‖}_{2} \qquad ( 24 )$$

Since the least square estimation approach is highly sensitive to noise, an outlier rejection may be applied to reduce the effect of noisy/spurious radar detections. As discussed above, the outlier rejection may include a RANSAC-based approach. More specifically, for every k^{th} iteration of V_{ref}, the RANSAC-based approach selects a random number of detections M to determine the velocity profile of equations (instead of using all N detections). For example, the random number of detections M may be selected such that the number of cycle operations N is greater than or equal to the random number of detections M which is greater than or equal to four. The RANSAC-based approach estimates the Cartesian velocity of the object under consideration using these random number of detections M by solving the least squares problem. Thereafter, using the estimated Cartesian velocity, the RANSAC-based approach estimates (i.e., back-computes) the reprojected range rate values of the individual detections according to:

$${r}_{i}^{reproj} = {v}_{x}^{ref} cos {θ}_{i} + {v}_{y}^{ref} sin {θ}_{i} + ω ( ( {y}_{i} - {y}_{ref} cos {θ}_{i} ) - ( {x}_{i} - {x}_{ref} sin {θ}_{i} ) ) \qquad ( 25 )$$

Thereafter, the RANSAC-based approach determines the normalized reprojection error of each detection according to:

$${error}_{norm} = \frac{\vert {r}_{i}^{reproj} - {r}_{i}^{meas} \vert}{\vert {r}_{i}^{reproj} \vert} \qquad ( 26 )$$

In Equation (26), errorₙₒᵣₘ represents the reprojection error (i.e., error between the reported range-rate and the reprojected range-rate). Using the individual reprojection errors (from Equation (26)), the RANSAC-based approach classifies the detections as either inliers or outliers based on a predetermined threshold error value. For example, when the reprojection error is greater than the predetermined threshold error value, the detection is classified as an inlier, and when the reprojection error is less than the predetermined threshold error value, the detection is classified as an outlier. The RANSAC-based approach may repeat this process for different values of M and record the number of inliers for each iteration k of V_{ref} and select the set of detections with a greatest number of inliers and the corresponding velocity estimates for processing by the detection model. That is, the set of detections with the greatest number of inliers are selected as the suitable candidate detections for each k^{th} iteration and the corresponding value of the Cartesian velocities are recorded for this value of yaw-rate ωₖ.

Accordingly, the vehicular sensing system or vehicular driving assist system may include a sensor, for example, a radar sensor, a lidar sensor, or an ultrasonic sensor that captures sensor data. In some examples, the vehicular sensing system includes a single sensor (e.g., a single radar sensor). In other examples, the vehicular sensing system includes a plurality of sensors (e.g., multiple radar sensors, such as multiple corner radar sensors). Here, the vehicular sensing system may only process sensor data from a single sensor at any given time or may process sensor data from one or more of the plurality of sensors at any given time. The sensor data includes angular velocities from multiple different points of an object detected by the sensor. As such, each of the multiple different points of the detected object may be associated with a different angular velocity.

The vehicular sensing system may detect the presence of an object (such as a pedestrian or another vehicle) exterior of the vehicle responsive to processing sensor data. The sensing system may operate over a predetermined range of yaw-rates (i.e., angular velocities) corresponding to known road curvatures, vehicle maneuvers, etc. In some implementations, vehicular sensing system processes the sensor data at a first time step to determine a first set of first angular velocities from the multiple different points of the detected object and determine a second set of second angular velocities from the multiple different points of the detected object. Each angular velocity of the first set of angular velocities may be associated with a respective point on the detected object at the first time step. Thus, each angular velocity of the first set of angular velocities may be determined independent of each other angular velocity of the first set of angular velocities. For example, a front corner of a leading vehicle in front of the equipped vehicle may be traveling at a greater velocity than a rear corner of the leading vehicle when the leading vehicle is turning. Similarly, each angular velocity of the second set of angular velocities may be associated with a respective point on the detected object at the second time step. Thus, each angular velocity of the second set of angular velocities may be determined independent of each other angular velocity of the second set of angular velocities.

The first and second time steps may be adjacent time steps corresponding to two adjacent points in time that the radar sensor captures radar data. That is, the radar sensor may operate at a predetermined frequency, such as 50 Hertz, whereby at each time step the radar sensor obtains radar data. Thus, each first angular velocity corresponds to a respective point of the detected object and is associated with a second angular velocity corresponding to the same respective point of the detected object. Notably, however, the radar sensing system is compatible with Cartesian velocities of the detected object to perform object detection and object tracking and not angular velocities captured by the radar sensor. As such, the radar sensing system converts the first set of first angular velocities into a corresponding first set of first Cartesian velocities and converts the second set of second angular velocities into a corresponding second set of second Cartesian velocities. Simply put, the radar sensing system converts the angular velocities into corresponding Cartesian (i.e., linear velocities). Notably, the detected object may include different Cartesian velocities at each of the multiple different points of the detected object.

Moreover, the sensing system generates a set of paired Cartesian velocities by pairing each first Cartesian velocity from the first set of Cartesian velocities with a corresponding one of the second Cartesian velocities from the second set of Cartesian velocities. Here, each pair of Cartesian velocities from the set of paired Cartesian velocities includes a respective first Cartesian velocity and a respective second Cartesian velocity both corresponding to a same respective point from the detected object. Each pair of Cartesian velocities may include the same Cartesian velocity or different Cartesian velocities. In some implementations, the sensing system may pair the velocities before converting the angular velocities to Cartesian velocities and then convert the paired angular velocities to Cartesian velocities. Thereafter, the sensing system determines a set of object Cartesian velocities of the detected object based on the set of paired Cartesian velocities. Each Cartesian velocity of the set of object Cartesian velocities may be associated with a respective point on the detected object and may be determined independent of each other object Cartesian velocity of the set of object Cartesian velocities. Thus, each Cartesian velocity of the set of object Cartesian velocities may be different from at least one other Cartesian velocity of the set of object Cartesian velocities.

The set of object Cartesian velocities may represent a current or instantaneous Cartesian velocity of the detected object based on the set of paired Cartesian velocities. That is, while the set of object Cartesian velocities may represent a velocity at each respective point of the object, the sensing system may also determine an overall velocity of the detected object based on the set of object Cartesian velocities. The instantaneous Cartesian velocity may be a semi-instantaneous Cartesian velocity. The vehicular sensing system may provide the set of object Cartesian velocities of the detected object to an advanced driver or driving assistance system of the vehicle that may track a predicted path of the detected object and control operation of the vehicle (e.g., acceleration, declaration/braking, steering, etc.) based on the predicted path of the detected object. The vehicular sensing system may determine a non-linear predicted path of the detected object based on the set of object Cartesian velocities and provide the non-linear predicted path to the advanced driver assistance system. For example, the non-linear predicted path may include the detected object turning. In some examples, the sensing system controls the equipped vehicle based on the set of paired Cartesian velocities for the detected object. The sensing system may determine the velocity of the detected object relative to the equipped vehicle based on the set of paired Cartesian velocities for the detected object and control the equipped vehicle based at least in part on the determined velocity of the detected object relative to the equipped vehicle.

Controlling the equipped vehicle may include controlling acceleration of the equipped vehicle and/or steering of the equipped vehicle and/or braking of the equipped vehicle. Thus, the system may control the equipped vehicle to avoid colliding with the detected object. In some examples, the detected object may include a leading vehicle in front of the equipped vehicle that is within a traffic lane along which the equipped vehicle is traveling. Here, controlling the equipped vehicle may include controlling the equipped vehicle (e.g., controlling steering of the equipped vehicle and/or controlling speed of the equipped vehicle via accelerating or decelerating the equipped vehicle) to follow the leading vehicle and to maintain a set distance from the leading vehicle, or to decelerate the equipped vehicle (e.g., controlling speed of the equipped vehicle via braking of the equipped vehicle) if it is determined that the leading vehicle is slowing down or stopping.

Advantageously, determining the Cartesian (i.e., linear) velocity of the detected object in this manner allows the sensing system to estimate both linear (in Cartesian coordinates) and angular velocities of the detected object using a single sensor (e.g., a radar or lidar sensor). Thus, the constraints on vehicle maneuvers can be expanded because the sensing system can detect angular movement in addition to linear movement of the objects surrounding the vehicle. Moreover, different points of detected objects are no longer assumed to each have the same linear velocity enabling a better understanding of the velocity of detected objects.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a sensor disposed at a vehicle equipped with the vehicular driving assist system, the sensor sensing exterior of the equipped vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises at least one data processor;
wherein the ECU is operable to process captured sensor data provided to the ECU;
wherein the vehicular driving assist system, via processing at the ECU of sensor data captured by the sensor, detects an object present exterior of the equipped vehicle;
wherein the vehicular driving assist system, via processing at the ECU of captured sensor data, determines a first set of angular velocities for the detected object;
wherein the vehicular driving assist system, via processing at the ECU of captured sensor data, determines a second set of angular velocities for the detected object;
wherein the first set of angular velocities for the detected object is determined at a first time and the second set of angular velocities for the detected object is determined at a second time that is after the first time;
wherein the vehicular driving assist system converts (i) the first set of angular velocities into a first set of Cartesian velocities and (ii) the second set of angular velocities into a second set of Cartesian velocities;
wherein the vehicular driving assist system pairs each angular velocity from the first set of angular velocities with a corresponding angular velocity from the second set of angular velocities to generate a set of paired Cartesian velocities for the detected object; and
wherein the vehicular driving assist system, based on the set of paired Cartesian velocities for the detected object, determines velocity of the detected object relative to the equipped vehicle and controls the equipped vehicle based at least in part on the determined velocity of the detected object relative to the equipped vehicle.

2. The vehicular driving assist system of claim 1, wherein the vehicular driving assist system, responsive to generating the set of paired Cartesian velocities, determines a set of object Cartesian velocities for the detected object based on the set of paired Cartesian velocities, and wherein each Cartesian velocity of the set of object Cartesian velocities is associated with a respective point on the detected object and is determined independent of each other object Cartesian velocity of the set of object Cartesian velocities.

3. The vehicular driving assist system of claim 2, wherein each Cartesian velocity of the set of object Cartesian velocities is different from at least one other Cartesian velocity of the set of object Cartesian velocities.

4. The vehicular driving assist system of claim 2, wherein the vehicular driving assist system filters the object Cartesian velocities by (i) selecting a subset of angular velocities from the first set of angular velocities and the second set of angular velocities to generate the set of paired Cartesian velocities, (ii) determining an error for each angular velocity in the selected subset of angular velocities based on the set of object Cartesian velocities and (iii) discarding angular velocities in the selected subset of angular velocities with determined errors greater than an error threshold.

5. The vehicular driving assist system of claim 2, wherein the vehicular driving assist system determines a non-linear predicted path of the detected object based on the set of object Cartesian velocities, and wherein the vehicular driving assist system controls the equipped vehicle based on the non-linear predicted path of the detected object.

6. The vehicular driving assist system of claim 2, wherein the vehicular driving assist system determines one or more candidate sets of object Cartesian velocities based on a range of yaw rates, and wherein each determined candidate set of object Cartesian velocities is determined based on a respective yaw rate of the range of yaw rates.

7. The vehicular driving assist system of claim 6, wherein the vehicular driving assist system determines a particular yaw rate from the range of yaw rates that minimizes an error between a set of predicted angular velocities and the first set of angular velocities or the second set of angular velocities, and wherein the vehicular driving assist system selects the determined candidate set of object Cartesian velocities based on the particular yaw rate as the set of object Cartesian velocities of the detected object.

8. The vehicular driving assist system of claim 1, wherein the vehicular driving assist system, based on the set of paired Cartesian velocities for the detected object, determines heading of the detected object relative to the equipped vehicle.

9. The vehicular driving assist system of claim 1, wherein the sensor comprises a single sensor.

10. The vehicular driving assist system of claim 1, wherein each angular velocity of the first set of angular velocities is associated with a respective point on the detected object at the first time, and wherein each angular velocity of the first set of angular velocities is determined independent of each other angular velocity of the first set of angular velocities.

11. The vehicular driving assist system of claim 1, wherein each angular velocity of the second set of angular velocities is associated with a respective point on the detected object at the second time, and wherein each angular velocity of the second set of angular velocities is determined independent of each other angular velocity of the second set of angular velocities.

12. The vehicular driving assist system of claim 1, wherein each angular velocity of the first set of angular velocities is different from at least one other angular velocity of the first set of angular velocities, and wherein each angular velocity of the second set of angular velocities is different from at least one other angular velocity of the second set of angular velocities.

13. The vehicular driving assist system of claim 1, wherein the vehicular driving assist system filters the set of paired Cartesian velocities using an outlier rejection process.

14. The vehicular driving assist system of claim 13, wherein the outlier rejection process comprises a random sample consensus (RANSAC) filtering process.

15. The vehicular driving assist system of claim 1, wherein the vehicular driving assist system controls the equipped vehicle by controlling at least one selected from the group consisting of (i) acceleration of the vehicle and (ii) steering of the vehicle.

16. The vehicular driving assist system of claim 1, wherein the sensor comprises at least one selected from the group consisting of (i) an ultrasonic sensor and (ii) a lidar sensor.

17. The vehicular driving assist system of claim 1, wherein the sensor comprises a radar sensor, and wherein the radar sensor transmits radio signals and receives radio signals, and wherein sensor data is captured based on the received radio signals.

18. The vehicular driving assist system of claim 17, wherein captured sensor data further comprises (i) range data, (ii) azimuth data, (iii) elevation data and (iv) power data.

19. The vehicular driving assist system of claim 1, wherein controlling the equipped vehicle comprises controlling the equipped vehicle to avoid colliding with the detected object.

20. The vehicular driving assist system of claim 1, wherein the detected object comprises a leading vehicle in front of the equipped vehicle and within a traffic lane along which the equipped vehicle is traveling, and wherein controlling the equipped vehicle comprises controlling the equipped vehicle to follow the detected leading vehicle.

21. The vehicular driving assist system of claim 1, wherein the detected object comprises another vehicle traveling along a road that intersects the road along which the equipped vehicle is traveling, and wherein controlling the equipped vehicle comprises controlling the equipped vehicle to avoid collision with the detected other vehicle.

22. The vehicular driving assist system of claim 1, wherein the detected object comprises a pedestrian, and wherein controlling the equipped vehicle comprises controlling the equipped vehicle to avoid the detected pedestrian.

23. A vehicular driving assist system, the vehicular driving assist system comprising:
a sensor disposed at a vehicle equipped with the vehicular driving assist system, the sensor sensing exterior of the equipped vehicle;
wherein the sensor is operable to capture sensor data;
an electronic control unit (ECU) comprising electronic circuitry and associated software;
wherein sensor data captured by the sensor is transferred to the ECU;
wherein the electronic circuitry of the ECU comprises at least one data processor;
wherein the ECU is operable to process captured sensor data provided to the ECU;
wherein the vehicular driving assist system, via processing at the ECU of sensor data captured by the sensor, detects an object present exterior of the equipped vehicle;
wherein the vehicular driving assist system, via processing at the ECU of captured sensor data, determines a first set of angular velocities for the detected object, and wherein each angular velocity of the first set of angular velocities is different from at least one other angular velocity of the first set of angular velocities, and wherein each angular velocity of the first set of angular velocities is determined independent of each other angular velocity of the first set of angular velocities;
wherein the vehicular driving assist system, via processing at the ECU of captured sensor data, determines a second set of angular velocities for the detected object, and wherein each angular velocity of the second set of angular velocities is different from at least one other angular velocity of the second set of angular velocities, and wherein each angular velocity of the second set of angular velocities is determined independent of each other angular velocity of the second set of angular velocities;
wherein the first set of angular velocities for the detected object is determined at a first time and the second set of angular velocities for the detected object is determined at a second time that is after the first time;
wherein the vehicular driving assist system converts (i) the first set of angular velocities into a first set of Cartesian velocities and (ii) the second set of angular velocities into a second set of Cartesian velocities;
wherein the vehicular driving assist system pairs each angular velocity from the first set of angular velocities with a corresponding angular velocity from the second set of angular velocities to generate a set of paired Cartesian velocities for the detected object; and
wherein the vehicular driving assist system, based on the set of paired Cartesian velocities for the detected object, determines velocity of the detected object relative to the equipped vehicle and controls the equipped vehicle based at least in part on the determined velocity of the detected object relative to the equipped vehicle.

24. The vehicular driving assist system of claim 23, wherein the vehicular driving assist system, responsive to generating the set of paired Cartesian velocities, determines a set of object Cartesian velocities for the detected object based on the set of paired Cartesian velocities, and wherein each Cartesian velocity of the set of object Cartesian velocities is associated with a respective point on the detected object and is determined independent of each other object Cartesian velocity of the set of object Cartesian velocities.

25. The vehicular driving assist system of claim 24, wherein each Cartesian velocity of the set of object Cartesian velocities is different from at least one other Cartesian velocity of the set of object Cartesian velocities.

26. The vehicular driving assist system of claim 24, wherein the vehicular driving assist system determines a non-linear predicted path of the detected object based on the set of object Cartesian velocities, and wherein the vehicular driving assist system controls the equipped vehicle based on the non-linear predicted path of the detected object.

27. The vehicular driving assist system of claim 23, wherein the vehicular driving assist system, based on the set of paired Cartesian velocities for the detected object, determines heading of the detected object relative to the equipped vehicle.

28. The vehicular driving assist system of claim 23, wherein the sensor comprises a single sensor.

29. A vehicular driving assist system, the vehicular driving assist system comprising:
a single sensor disposed at a vehicle equipped with the vehicular driving assist system, the single sensor sensing exterior of the equipped vehicle;
wherein the single sensor is operable to capture sensor data;
an electronic control unit (ECU) comprising electronic circuitry and associated software;
wherein sensor data captured by the single sensor is transferred to the ECU;
wherein the electronic circuitry of the ECU comprises at least one data processor;
wherein the ECU is operable to process captured sensor data provided to the ECU;
wherein the vehicular driving assist system, via processing at the ECU of sensor data captured by the single sensor, detects an object present exterior of the equipped vehicle;
wherein the vehicular driving assist system, via processing at the ECU of captured sensor data, determines a first set of angular velocities for the detected object;
wherein the vehicular driving assist system, via processing at the ECU of captured sensor data, determines a second set of angular velocities for the detected object;
wherein the first set of angular velocities for the detected object is determined at a first time and the second set of angular velocities for the detected object is determined at a second time that is after the first time;
wherein the vehicular driving assist system converts (i) the first set of angular velocities into a first set of Cartesian velocities and (ii) the second set of angular velocities into a second set of Cartesian velocities;
wherein the vehicular driving assist system pairs each angular velocity from the first set of angular velocities with a corresponding angular velocity from the second set of angular velocities to generate a set of paired Cartesian velocities for the detected object;
wherein the vehicular driving assist system, responsive to generating the set of paired Cartesian velocities, determines a set of object Cartesian velocities for the detected object, and wherein each Cartesian velocity of the set of object Cartesian velocities is associated with a respective point on the detected object and is determined independent of each other object Cartesian velocity of the set of object Cartesian velocities; and
wherein the vehicular driving assist system, based on the set of object Cartesian velocities for the detected object, determines velocity of the detected object relative to the equipped vehicle and controls the equipped vehicle based at least in part on the determined velocity of the detected object relative to the equipped vehicle.

30. The vehicular driving assist system of claim 29, wherein each angular velocity of the first set of angular velocities is associated with a respective point on the detected object, and wherein each angular velocity of the first set of angular velocities is determined independent of each other angular velocity of the first set of angular velocities.

31. The vehicular driving assist system of claim 29, wherein each angular velocity of the second set of angular velocities is different from at least one other angular velocity of the second set of angular velocities, and wherein each angular velocity of the second set of angular velocities is determined independent of each other angular velocity of the second set of angular velocities.

32. The vehicular driving assist system of claim 29, wherein the vehicular driving assist system determines a non-linear predicted path of the detected object based on the set of object Cartesian velocities, and wherein the vehicular driving assist system controls the equipped vehicle based on the non-linear predicted path of the detected object.

33. The vehicular driving assist system of claim 29, wherein the vehicular driving assist system, based on the set of object Cartesian velocities for the detected object, determines heading of the detected object relative to the equipped vehicle.
